(19) United States
(12) Patent Application Publication
(10) Pub. No.: US 2025/0192529 A1
(43) Pub. Date: Jun. 12, 2025

(54) ELECTRICAL JUNCTION BOX

(71) Applicant: Sumitomo Wiring Systems, Ltd., Yokkaichi-Shi (JP)

(72) Inventors: Kiyofumi KAWAGUCHI, Yokkaichi-Shi (JP); Tatsuya FUJISAKA, Yokkaichi-Shi (JP)

(73) Assignee: Sumitomo Wiring Systems, Ltd., Yokkaichi-Shi (JP)

(21) Appl. No.: 18/972,405

(22) Filed: Dec. 6, 2024

(30) Foreign Application Priority Data
Dec. 7, 2023 (JP) 2023-207075

(51) Int. Cl. H02G 3/08; H02G 3/16

(52) U.S. Cl. CPC H02G 3/088; H02G 3/083; H02G 3/16

(57) ABSTRACT

Provided is an electrical junction box that is able to improve heat dissipation inside a metal housing. An electrical junction box includes a relay unit for use in relay connection of a wire and a metal housing that houses the relay unit. The relay unit has a relay attached to a resin component housed inside the metal housing. The metal housing has a heat dissipation part formed by raising a position opposing the relay toward the relay. The heat dissipation part dissipates heat emanating from the relay to outside the metal housing.

### CROSS-REFERENCE TO RELATED APPLICATIONS

This application claims priority of Japanese Patent Application No. JP 2023-207075 filed on Dec. 7, 2023, the contents of which are incorporated herein.

### TECHNICAL FIELD

The present disclosure relates to an electrical junction box.

### BACKGROUND

Conventionally, electrical junction boxes in which a plurality of shielded wires are relayed by relays, fuses, and the like, as disclosed in JP 2014-212608A, are well known. The electrical junction box of JP 2014-212608A is provided with a box body having an upper case that is closed by a cover and a lower case that is attached to the back surface of the upper case. The lower case has busbars that connect a plurality of shielded wires housed within the box body through wire outlets formed in a wall surface of the upper case. The plurality of shielded wires are disposed on an upper surface of the upper case, and terminals at leading ends thereof are fixed to the busbars of the lower case by a fastening structure of bolts and nuts.

JP 2014-212608A is an example of related art.

Incidentally, in the case of shielded wires that carry high voltage current, relays and fuses generate heat, and thus the inside of the box body tends to become hot. In particular, in the case where the box body is made of metal, heat tends to accumulate inside the box body. Therefore, there is demand for development of technologies that are able to improve heat dissipation in this type of electrical junction box.

An object of the present disclosure is to provide an electrical junction box that is able to improve heat dissipation inside a metal housing.

### SUMMARY

An electrical junction box that resolves the above problem is a configuration including a relay unit for use in relay connection of an electrical wire and a metal housing housing the relay unit, in which the relay unit has a relay attached to a resin component housed inside the metal housing, and the metal housing has a heat dissipation part formed by raising a position opposing the relay toward the relay.

The present disclosure is able to improve heat dissipation inside a metal housing.

### BRIEF DESCRIPTION OF THE DRAWINGS

FIG. 1 is a perspective view of an electrical junction box according to one embodiment.

FIG. 2 is a cross-sectional view taken along line II-II shown in FIG. 1.

FIG. 3 is an exploded perspective view of the electrical junction box.

FIG. 4 is a cross-sectional view taken along line IV-IV shown in FIG. 1.

FIG. 5 is an enlarged perspective view showing the shape of a heat dissipation part.

FIG. 6 is a partial cross-sectional view for describing the heat dissipation action of the heat dissipation part.

FIG. 7 is a partial cross-sectional view for describing the action of a discharge hole.

### DETAILED DESCRIPTION OF PREFERRED EMBODIMENTS

Initially, modes of the present disclosure will be enumerated and described.

In a first aspect, an electrical junction box of the present disclosure is a configuration including a relay unit for use in relay connection of an electrical wire and a metal housing housing the relay unit, in which the relay unit has a relay attached to a resin component housed inside the metal housing, and the metal housing has a heat dissipation part formed by raising a position opposing the relay toward the relay.

According to this configuration, part of the metal housing can be disposed as close as possible to the relay as a heat dissipation part. Thus, heat emanating from the relay can be efficiently emitted to outside the metal housing via the heat dissipation part of the metal housing. Therefore, heat dissipation inside the metal housing can be improved.

In a second aspect according to the first aspect, a distal end of the heat dissipation part that receives heat emanating from the relay may be formed in a planar shape. According to this configuration, heat from the relay can be received and dissipated with a large planar surface, thus further contributing to improving heat dissipation inside the metal housing.

In a third aspect according to the first or the second aspect, the relay unit may have a busbar attached to the resin component and used as wiring of the resin component, and the heat dissipation part may be formed by raising the metal housing at a position opposing the busbar connected to the relay. According to this configuration, heat transmitted from the relay to the busbar can be smoothly emitted to outside the metal housing by the heat dissipation part located opposite the busbar. Therefore, this further contributes to improving heat dissipation inside the metal housing.

In a fourth aspect according to any of the first through the third aspects, the relay unit may have a busbar attached to the resin component and used as wiring of the resin component, and the metal housing may have a housing hole for externally leading out an electrical wire of a connector attached to the resin component and electrically connected to the busbar, and a fluid passage part located at a position on a bottom surface of the metal housing lower than the heat dissipation part and serving as a passage for fluid that has infiltrated the metal housing through the housing hole. According to this configuration, even if fluid infiltrates the metal housing through the housing hole, the fluid flows through the fluid passage part, and thus the fluid is unlikely to adhere to electronic components such as the busbar. Also, when the heat dissipation part is formed in a bottom portion of the metal housing, for example, the region other than the raised heat dissipation part can be used as the fluid passage part. Therefore, the shape of the inside of the bottom portion of the metal housing can be effectively utilized.

In a fifth aspect according to any of the first through the fourth aspects, the metal housing may have a discharge hole for discharging the fluid flowing through the fluid passage part to outside the metal housing. According to this configuration, fluid flowing through the fluid passage part is discharged to outside the metal housing through the discharge hole, and thus adhesion of fluid to electronic components such as the busbar can be further suppressed.

Specific examples of the present disclosure will be described below with reference to the drawings. Note that the present disclosure is not limited to these examples, and is indicated by the claims, and all changes that come within the meaning and range of equivalency of the claims are intended to be embraced therein. In the diagrams, part of the configuration may be shown in an exaggerated or simplified manner for convenience of description. Also, the dimensional ratios of various portions may differ from the actual dimensions.

### Electrical Junction Box 1

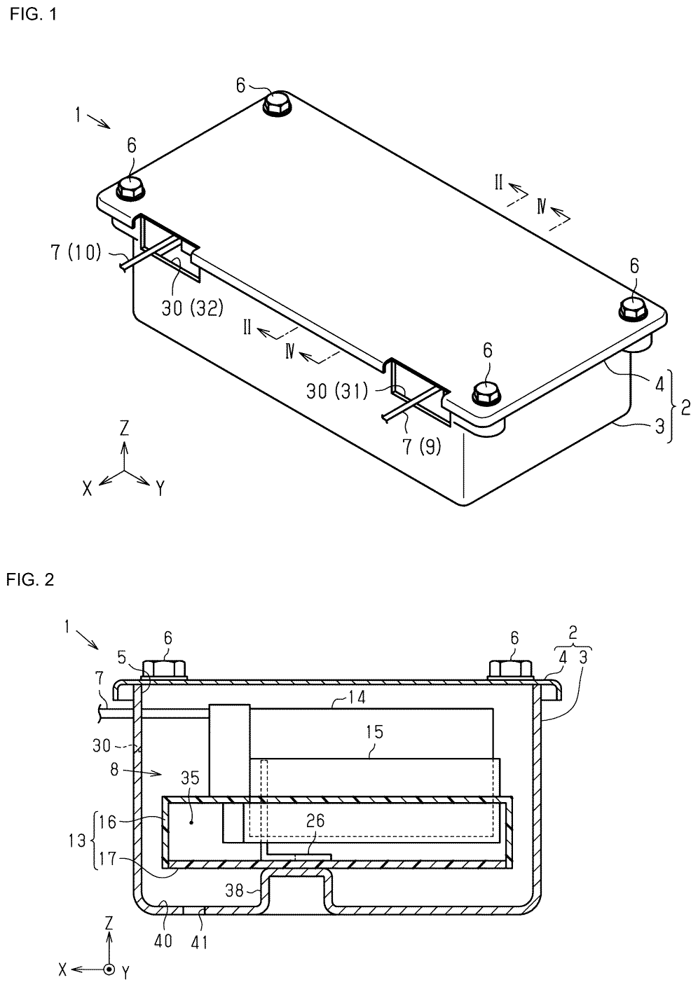

As shown in FIG. 1, an electrical junction box 1 is provided with a metal housing 2 having noise resistance as a housing of the electrical junction box 1. The metal housing 2 has, for example, a housing body 3 that forms a main body portion of the metal housing 2 and an upper cover 4 that closes an opening 5 (see FIG. 2, etc.) of the housing body 3. The housing body 3 is, for example, made of aluminum. The housing body 3 is, for example, open in an upper portion.

The upper cover 4 is, for example, formed in a rectangular plate shape. The upper cover 4 is, for example, made of iron. The upper cover 4 is, for example, fixed to the housing body 3 by a fastening member 6 such as a plurality of screws at the four corners of the upper cover 4.

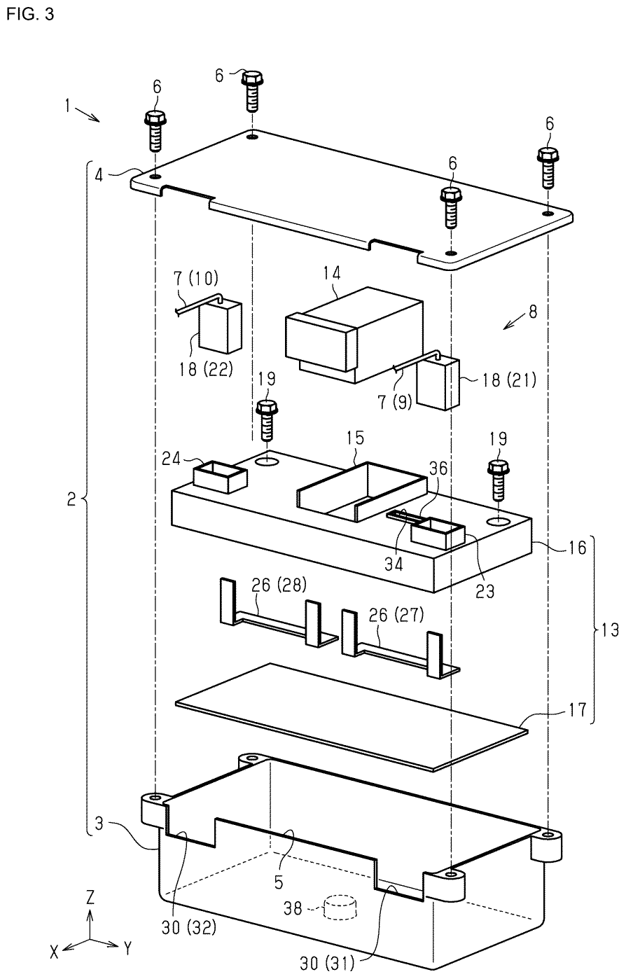

As shown in FIGS. 2 and 3, in the electrical junction box 1, a relay unit 8 that is used for relay connection of wires 7 is housed inside the metal housing 2. In this way, the electrical junction box 1 is a member that relays an electrical component joined to one wire 7 (in this example, first wire 9) and an electrical component joined to another wire 7 (in this example, second wire 10). The wires 7 are, for example, high-voltage wires. When an overvoltage or overcurrent is applied to the wires 7, for example, the electrical junction box 1 protects an electrical circuit connected to the wires 7, by using the relay unit 8 to break the electrical circuit.

### Relay Unit 8

As shown in FIGS. 2 and 3, the relay unit 8 has a relay 14 attached to a resin component 13 housed inside the metal housing 2. The relay 14 is attached and fixed to a relay attachment part 15 formed on an upper surface of the resin component 13 at a central position in the width direction of the resin component 13 (Y-axis direction in FIG. 3). The relay 14 switches an electrical circuit having a relay function on/off with a contact (not shown) provided within a relay case. The relay 14 breaks the electrical circuit having the relay function when an overvoltage or overcurrent occurs, for example.

The resin component 13 is a member for attaching and supporting electronic components that are installed in the relay unit 8. The resin component 13 has, for example, a resin component body 16 that forms a main body of the resin component 13 and a protective cover 17 that protects the back surface of the resin component body 16. The above-mentioned relay 14, connectors 18 provided at the leading ends of the wires 7 (see FIG. 3), and the like are attached to the resin component body 16. The resin component body 16 is, for example, formed in a bottomless hollow shape. The protective cover 17 is fixed to a bottom portion of the resin component body 16 by a screw (not shown), for example. The resin component 13 is, for example, fixed to the metal housing 2 (in this example, housing body 3) by a fastening member 19 such as a plurality of screws.

The connectors 18 include a first connector 21 provided at the leading end of the first wire 9 and a second connector 22 provided at the leading end of the second wire 10. The first connector 21 is attached to a first connector attachment part 23 disposed on the upper surface of the resin component 13 at one end portion in the width direction of the resin component 13 (Y-axis direction in FIG. 3). The second connector 22 is attached to a second connector attachment part 24 disposed on the upper surface of the resin component 13 at the opposite end portion in the width direction of the resin component 13 (Y-axis direction in FIG. 3).

The relay unit 8 has busbars 26 that are attached to the resin component 13 and used as wiring of the resin component 13. The busbars 26 are, for example, wiring that carries a large current. The busbars 26 are, for example, attached and fixed to the back surface of the resin component body 16 by screws (not shown). In the case of this example, the busbars 26 include, for example, a first busbar 27 that electrically connects the relay 14 and the first connector 21 and a second busbar 28 that electrically connects the relay 14 and the second connector 22.

The first wire 9 is connected to one terminal of the relay 14 via the first connector 21 and the first busbar 27. The second wire 10 is connected to the other terminal of the relay 14 via the second connector 22 and the second busbar 28. In this way, the relay unit 8 has an electrical path from the first wire 9 to the first connector 21, the first busbar 27, the relay 14, the second busbar 28, the second connector 22, and the second wire 10 in the stated order.

Note that the relay unit 8 may have a plurality of pairs of wires 7. In this case, the relay unit 8 is not limited to having only one relay 14 and may have a plurality of relays 14. The relay unit 8 may have a fuse as a measure against overcurrent on the wires 7. That is, the relay unit 8 may have both the relay 14 and a fuse. Also, the number of busbars 26 may be changed as appropriate, according to the number of relays 14 and fuses provided in the relay unit 8.

### Housing Holes 30

As shown in FIGS. 1 to 3, the metal housing 2 has housing holes 30 for externally leading out the wires 7 (first wire 9 and second wire 10) of the connectors 18 that are attached to the resin component 13 and electrically connected to the busbars 26. The housing holes 30 are, for example, formed by cutting out end portions of the side wall of the housing body 3 in the height direction (+Z axis direction in FIG. 1, etc.). In the case of this example, the housing holes 30 include, for example, a first housing hole 31 for leading the first wire 9 out of the housing and a second housing hole 32 for leading the second wire 10 out of the housing. The housing holes 30 are for ventilating the metal housing 2, in order to keep the temperature within the metal housing 2 from rising.

### Heat Dissipation Measures of Resin Component 13

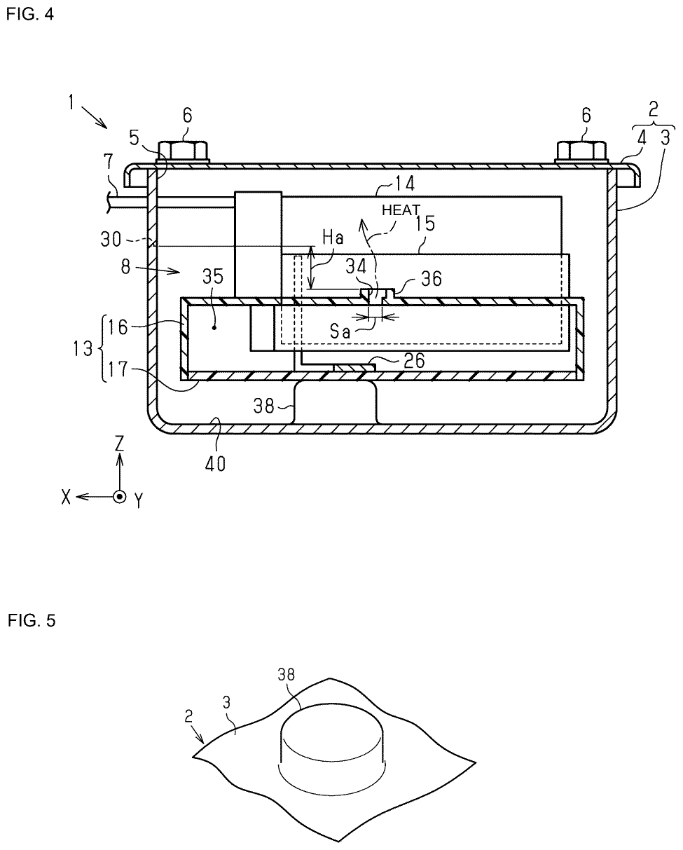

As shown in FIGS. 3 and 4, the resin component 13 has a heat dissipation hole 34 for dissipating heat of the relay unit 8 generated when current flows through the relay unit 8. The heat dissipation hole 34 is a hole through which a spatial region 35 inside the resin component 13 communicates with outside the resin component 13. The heat dissipation hole 34 has a peripheral protruding wall 36 around the hole periphery disposed on the surface of the resin component 13. The heat dissipation hole 34 is formed in a rectangular shape as viewed from the direction of the opening of the hole (Z-axis direction in FIGS. 3, 4, etc.). There may be one heat dissipation hole 34 or a plurality thereof. The busbars 26, a fuse not shown, and the like, for example, are disposed in the spatial region 35.

As shown in FIG. 4, the heat dissipation hole 34 is, for example, preferably disposed close to the relay 14. This is because the relay 14 tends to become hot, and heat generated by the relay 14 is efficiently dissipated via the heat dissipation hole 34. In particular, the heat dissipation hole 34 is preferably disposed upward of the busbars 26 in the height direction of the resin component 13 (Z-axis direction in FIG. 4, etc.). Note that disposing the heat dissipation hole 34 at a position close to the relay 14 means, for example, disposing the heat dissipation hole 34 directly next to the relay attachment part 15.

Also, the heat dissipation hole 34 is, for example, preferably disposed close to the housing holes 30. This is because heat from the heat dissipation hole 34 is efficiently discharged to outside the housing via the housing holes 30. Note that disposing the heat dissipation hole 34 at a position close to the housing holes 30 means, for example, disposing the heat dissipation hole 34 at a position closer to the housing holes 30 than the center in the depth direction of the resin component 13 (X-axis direction in FIG. 4, etc.).

An area Sa of the opening of the heat dissipation hole 34 (see FIG. 4) is, for example, set to be large enough for hot air to flow through. The heat dissipation hole 34 is set to a height that is a predetermined distance Ha from the housing holes 30 in the height direction of the metal housing 2 (Z-axis direction in FIG. 4). That is, the heat dissipation hole 34 is disposed at a lower position than the hole lower ends of the housing holes 30 in the height direction of the metal housing 2. This is in order to dispose the heat dissipation hole 34 as far as possible from the housing holes 30.

As shown in FIG. 3, the heat dissipation hole 34 is provided only at a position opposing the first busbar 27, out of the first busbar 27 and the second busbar 28. Note that, in the case of this example, the heat dissipation hole 34 is provided only at a position opposing the first busbar 27, out of the first busbar 27 and the second busbar 28, but the heat dissipation hole 34 may be provided at positions respectively opposing the first busbar 27 and the second busbar 28. Also, the present embodiment is not limited to only one heat dissipation hole 34 being provided for one heat dissipation target and a plurality of heat dissipation holes 34 may be provided for one heat dissipation target.

### Heat Dissipation Measures of Metal Housing 2

As shown in FIGS. 2 and 3, the metal housing 2 has a heat dissipation part 38 formed by raising a position opposing the relay 14 toward the relay 14. In the case of this example, the heat dissipation part 38 is formed by raising the metal housing 2 at a position opposing the busbars 26 connected to the relay 14. In the case of this example, the heat dissipation part 38 is formed in a bottom portion of the metal housing 2. That is, the heat dissipation part 38 is disposed directly under the busbars 26 connected to the relay 14.

As shown in FIG. 5, the distal end of the heat dissipation part 38 that receives heat generated by the relay 14 is, for example, formed in a planar shape. In this way, the heat dissipation part 38 is formed so as to receive heat emanating from the relay 14 with a planar surface. The heat dissipation part 38 is, for example, formed by bending a bottom portion of the metal housing 2 (housing body 3). In this way, the heat dissipation part 38 is formed by raising part of the bottom portion of the metal housing 2.

Measures against Fluid Infiltration into Housing

As shown in FIG. 2, the metal housing 2 has a fluid passage part 40 that serves as a passage for fluid on the bottom surface inside the metal housing 2. In the case of this example, the fluid passage part 40 is located at a position on the bottom surface of the metal housing 2 lower than the heat dissipation part 38 and serves as a passage for fluid that has infiltrated the metal housing 2 through the housing holes 30. The fluid passage part 40 refers, for example, to a portion of the bottom surface of the metal housing 2 (housing body 3) in which the heat dissipation part 38 does not exist.

The metal housing 2 has a discharge hole 41 for discharging fluid flowing through the fluid passage part 40 to outside the metal housing 2. The discharge hole 41 is, for example, formed in a bottom portion of the housing body 3. In this way, in the case of this example, fluid flowing through the fluid passage part 40 is discharged to outside the metal housing 2 via the discharge hole 41 formed in the housing body 3. Note that the number of discharge holes 41 and the arrangement positions thereof are not particularly limited.

Next, operation of the electrical junction box 1 of the present embodiment will be described.

### Function of Heat Dissipation

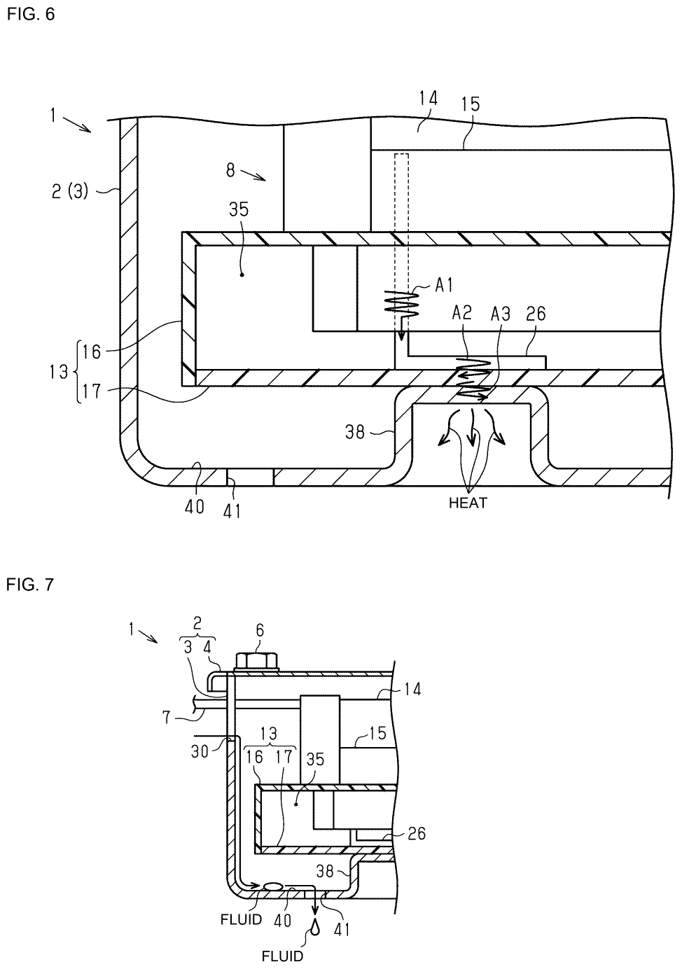

As shown in FIG. 6, when current flows through the relay unit 8 of the electrical junction box 1, the electronic components of the relay unit 8 become hot and this heat is transmitted peripherally. In particular, the relay unit 8 is surrounded by the metal housing 2, and thus there is a tendency for heat to be trapped and for the electronic components of the relay unit 8 to become hot. That is, it is necessary to ensure that the electronic components of the relay unit 8 do not become excessively hot by improving the heat dissipation of the relay unit 8.

In the case of this example, when current flows through the relay unit 8, a heat generation path indicated by “A1” in FIG. 6 occurs due to the relay 14 generating heat. That is, when current flows through the electrical circuit of the relay unit 8, the relay 14 which is a heat generating body of the relay unit 8 generates heat, and heat is transmitted from the relay 14 to the busbars 26, as shown by the heat generation path “A1”. The heat transmitted to the busbars 26 is transmitted to the resin component 13, as shown by a heat generation path indicated by “A2” in FIG. 6. The heat transmitted to the resin component 13 is then transmitted to the metal housing 2, or more specifically, to the housing body 3, as shown by a heat generation path indicated by “A3” in FIG. 6.

In the case of this example, the heat dissipation part 38 is formed at a bottom portion of the housing body 3 by raising the bottom portion. This heat dissipation part 38 is formed by raising a bottom portion of the housing body 3 and is thus in close proximity to the resin component 13. Thus, the heat transmitted to the resin component 13 is efficiently transmitted to the housing body 3. Accordingly, heat transmitted from the resin component 13 can be efficiently dissipated by being released through the metal housing body 3. Therefore, high heat dissipation performance of the electrical junction box 1 is secured.

### Drainage Function

As shown in FIG. 7, the housing holes 30 for externally leading the wires 7 out of the metal housing 2 are formed in the metal housing 2, and thus fluid such as water, for example, could possibly enter the metal housing 2 through these housing holes 30. In the case of this example, the fluid passage part 40 is provided in a bottom surface of the housing body 3, and thus it becomes possible for fluid that has infiltrated the metal housing 2 to flow through the fluid passage part 40. That is, it becomes possible to ensure that a situation in which fluid that has infiltrated through the housing holes 30 adheres to electronic components of the relay unit 8 such as the relay 14 and the busbars 26 is unlikely to arise.

Also, because the discharge hole 41 is formed in a bottom portion of the housing body 3, fluid flowing through the fluid passage part 40 can be discharged to outside the housing body 3 through the discharge hole 41. Thus, it becomes possible to ensure that a situation in which fluid that has infiltrated the metal housing 2 remains inside the metal housing 2 is unlikely to arise. Therefore, this further contributes to ensuring that a situation in which fluid reaches the relay 14 or the busbars 26 of the relay unit 8 is unlikely to arise.

### Effects of Embodiment

According to the configuration of the above embodiment, effects such as the following can be obtained.

In the electrical junction box 1, the relay unit 8 that is used in relay connection of the wires 7 is housed inside the metal housing 2. The relay unit 8 has the relay 14 attached to the resin component 13 that is housed inside the metal housing 2. The metal housing 2 has the heat dissipation part 38 formed by raising a position opposing the relay 14 toward the relay 14.

According to the present configuration, part of the metal housing 2 can be disposed as close as possible to the relay 14 as the heat dissipation part 38. Thus, heat emanating from the relay 14 can be efficiently emitted to outside the metal housing 2 via the heat dissipation part 38 on the bottom portion of the metal housing 2. Therefore, heat dissipation inside the metal housing 2 can be improved.

The distal end of the heat dissipation part 38 that receives heat emanating from the relay 14 is formed in a planar shape. According to this configuration, heat from the relay 14 can be received and dissipated with a large planar surface, thus further contributing to improving heat dissipation inside the metal housing 2.

The relay unit 8 has the busbars 26 that are attached to the resin component 13 and used as wiring of the resin component 13. The heat dissipation part 38 is formed by raising the metal housing 2 at a position opposing the busbars 26 connected to the relay 14. According to this configuration, heat transmitted from the relay 14 to the busbars 26 can be smoothly emitted to outside the metal housing 2 with the heat dissipation part 38 located opposite the busbars 26. Therefore, this further contributes to improving heat dissipation inside the metal housing 2.

The metal housing 2 has the housing holes 30 for externally leading out the wires 7 of the connectors 18 that are attached to the resin component 13 and electrically connected to the busbars 26 and the fluid passage part 40 that is located at a position on the bottom surface of the metal housing 2 lower than the heat dissipation part 38 and serves as a passage for fluid that has infiltrated the metal housing 2 through the housing holes 30. According to this configuration, even if fluid infiltrates the metal housing 2 through the housing holes 30, the fluid flows through the fluid passage part 40, and thus the fluid is unlikely to adhere to electronic components such as the busbars 26. Also, when the heat dissipation part 38 is formed in a bottom portion of the metal housing 2, for example, the region other than the raised heat dissipation part 38 can be used as the fluid passage part 40. Therefore, the shape of the inside of the bottom portion of the metal housing 2 can be effectively utilized.

The metal housing 2 has the discharge hole 41 for discharging fluid flowing through the fluid passage part 40 to outside the metal housing 2. According to this configuration, fluid flowing through the fluid passage part 40 is discharged to outside the metal housing 2 through the discharge hole 41, and thus adhesion of fluid to electronic components such as the busbars 26 can be further suppressed.

### Other Embodiments

Note that the present embodiment can be implemented in a modified manner as follows. The present embodiment and the following example changes can be implemented in combination with each other to the extent that no technical inconsistencies arise.

A plurality of heat dissipation parts 38 are preferably provided, according to the number of heat generating components provided in the resin component 13, for example. That is, the heat dissipation part 38 is preferably provided in correspondence to each relay 14 and fuse provided in the resin component 13.

The heat dissipation part 38 is not limited to a circular shape as viewed from above and may, for example, be changed to an elliptical shape, a square shape, or a triangular shape.

The heat dissipation part 38 is, for example, preferably in close contact with the resin component 13. In this case, a higher heat dissipation effect can be obtained.

The heat dissipation part 38 is not limited to being disposed at a position corresponding to the busbars 26 and may be provided at a position where the busbars 26 are not disposed.

The heat dissipation part 38 is not limited to being provided in a bottom portion of the metal housing 2 and may, for example, be provided in an upper portion or a side portion.

The distal end of the heat dissipation part 38 is not limited to a planar shape and may, for example, be a square shape.

One heat dissipation part 38 or a plurality thereof may be provided. Also, when a plurality of heat dissipation parts 38 are provided, at least one thereof may be formed in a different shape from the others.

The metal housing 2 is not limited to a two-component configuration and may be constituted by one component or three or more components.

The material of the metal housing 2 is not particularly limited and may be any metal.

Heat-generating components other than the busbars 26 and fuses may be provided in the spatial region 35 of the resin component 13.

The resin component 13 is not limited to a hollow shape having the spatial region 35 and may simply be a plate shape by omitting the protective cover 17, for example.

The heat dissipation hole 34 is not limited to being formed in an upper wall of the resin component 13 and may, for example, be formed in a bottom wall or a side wall.

The heat dissipation hole 34 is not limited to externally dissipating heat within the spatial region 35 of the resin component 13. For example, when the resin component 13 is plate-shaped, that is, when the resin component 13 does not have the spatial region 35, the heat dissipation hole 34 may be constituted as a hole for releasing heat on the back side of the resin component 13 to the front side.

The heat dissipation hole 34 may have a shape in which the protruding wall 36 is omitted.

When a plurality of heat dissipation holes 34 are provided, at least one thereof may be formed in a different shape from the others.

Various shapes can be employed for the hole shape of the heat dissipation hole 34, such as a slit shape, a round hole shape, an elliptical shape, a square shape, and a triangular shape.

When the relay unit 8 is equipped with the relay 14 and a fuse, the heat dissipation target of the heat dissipation hole 34 is not limited to the relay 14 and may be the fuse. That is, the heat dissipation hole 34 is not limited to being disposed close to the wires 7 joined to the relay 14 and may be disposed close to wires 7 joined to the fuse.

The electrical junction box 1 (relay unit 8), when connected to a plurality of electrical components, for example, may have a function of branching and relaying input to each of the electrical components.

Although the present disclosure is described in accordance with the embodiments, it is understood that the disclosure is not limited to the described embodiments and structures. The disclosure also embraces various example modifications and modifications within a range of equivalency. Additionally, various combinations and forms, as well as other combinations and forms including only one element or more or less elements, also come within the category and spirit of the disclosure.

What is claimed is:

1. An electrical junction box comprising:
a relay unit for use in relay connection of an electrical wire; and
a metal housing housing the relay unit,
wherein the relay unit has a relay attached to a resin component housed inside the metal housing, and
the metal housing has a heat dissipation part formed by raising a position opposing the relay toward the relay.

2. The electrical junction box according to claim 1,
wherein a distal end of the heat dissipation part that receives heat emanating from the relay is formed in a planar shape.

3. The electrical junction box according to claim 1,
wherein the relay unit has a busbar attached to the resin component and used as wiring of the resin component, and
the heat dissipation part is formed by raising the metal housing at a position opposing the busbar connected to the relay.

4. The electrical junction box according to claim 1,
wherein the relay unit has a busbar attached to the resin component and used as wiring of the resin component, and
the metal housing has:
a housing hole for externally leading out an electrical wire of a connector attached to the resin component and electrically connected to the busbar; and
a fluid passage part located at a position on a bottom surface of the metal housing lower than the heat dissipation part and serving as a passage for fluid that has infiltrated the metal housing through the housing hole.

5. The electrical junction box according to claim 4,
wherein the metal housing has a discharge hole for discharging the fluid flowing through the fluid passage part to outside the metal housing.
